(19) United States
(12) Patent Application Publication
(10) Pub. No.: US 2003/0051704 A1
(43) Pub. Date: Mar. 20, 2003

(54) Multi-valve engine

(76) Inventors: Akiyoshi Mori, Fujisawa-shi (JP); Haruki Kobayashi, Fujisawa-shi (JP)

Correspondence Address: HENRICKS SLAVIN AND HOLMES LLP, SUITE 200, 840 APOLLO STREET, EL SEGUNDO, CA, 90245

(21) Appl. No.: 10/165,357

(22) Filed: Jun. 6, 2002

(30) Foreign Application Priority Data
Sep. 14, 2001 (JP) 2001-279043

(51) Int. Cl. F02N 3/00

(52) U.S. Cl. 123/321; 123/315; 123/432; 123/188.3

(57) ABSTRACT

A multi-valve engine comprises a plurality of intake and exhaust valves on a cylinder. Depending on use, one of the valves is made of higher heat-resistant material, and another is made of lower heat-resistant material, thereby decreasing cost and improving durability and reliability.

### BACKGROUND OF THE INVENTION

The present invention relates to a multi-valve engine on which a plurality of intake or exhaust valves are mounted to a cylinder.

In such a multi-valve gasoline engine, DOHC-type valve-operating mechanism, two intake and exhaust valves are usually mounted on a cylinder.

The intake and exhaust valves used in such a multi-valve are made of the same material for an intake or exhaust valve depending on form and specification of the engine.

Recently, owing to intensification in regulation of a toxic exhaust gas and reduction in discharge amount of CO₂, intake and exhaust conditions of a gasoline engine are inclined to vary widely. Various measures and changes in specifications are carried out. For example, to reduce NOx, a lot of EGR (exhaust gas recirculation) is carried out, or to increase fuel efficiency, swirling flow is formed in a conduit, or changing a phase of a camshaft. For example, internal EGR is conducted to reduce pumping loss to increase engine performance. The measures may especially affect an intake valve. To reduce NOx, a lot of EGR is made, and a high temperature gas passes through part or all of multi-valve provided intake valve to reflux into a cylinder to raise temperature of the intake valve.

To form a swirling flow in conduits, there is a method of stopping part of a multi-valve intake valve, but new air does not pass through a stopped intake valve, thereby decreasing cooling capability under the valve head to raise temperature.

Furthermore, to control new intake amount, internal EGR is carried out while multi-valve-type intake valve is partially stopped to raise temperature of stopped intake valve.

Measures for reducing toxic exhaust gas and increasing fuel efficiency increase thermal load of an intake valve to reduce heat resistance and accelerating wear. It becomes unreasonable in cost, reliability and engine performance to make a plurality of intake valves from the same material, since one intake valve becomes excessive quality to decrease durability.

In a multi-valve diesel engine, a plurality of intake valves are made of the same material, and a plurality of exhaust valves are made of the same material. In a diesel engine in which one exhaust valve is a little opened to actuate an exhaust brake, it involves disadvantages to make the valves of the same material.

### SUMMARY OF THE INVENTION

In view of the foregoing disadvantages, it is an object of the present invention to provide a multi-valve engine which decreases its cost to increase durability, reliability and engine performance by determining material of a plurality of intake and exhaust valves respectively depending on intake and exhaust conditions and use of valve.

### BRIEF DESCRIPTION OF THE DRAWINGS

These and other features and advantages will become more apparent from the following description with respect to embodiments as shown in the appended drawings wherein:

FIG. 1 is a schematic perspective view of the first embodiment of a multi-valve gasoline engine according to the present invention;

FIG. 2 is a schematic perspective view of the second embodiment of a multi-valve gasoline engine according to the present invention; and

FIG. 3 is a vertical front view of the third embodiment of a multi-valve gasoline engine according to the present invention.

### DETAILED DESRIPTION OF PREFERRED EMBODIMENTS

Embodiments of the present invention will be described with respect to appended drawings.

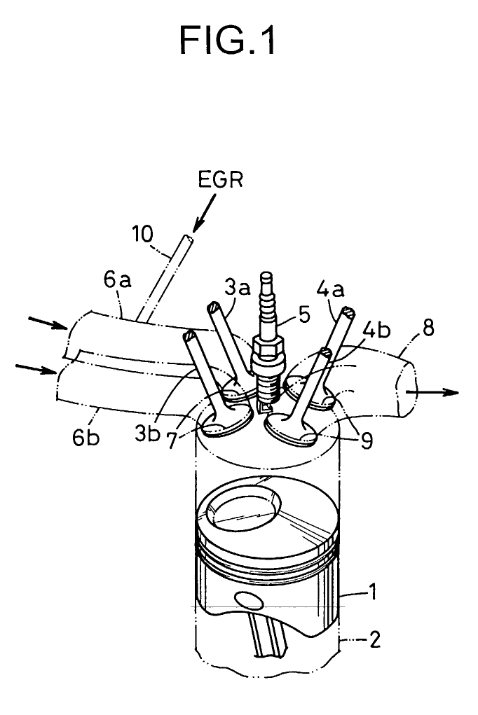

FIG. 1 illustrates the first embodiment of the present invention, which comprises part of a multi-valve internal combustion engine (a single cylinder) which has a DOHC-type valve-operating mechanism. Numeral 1 denotes a piston which moves up and down in a cylinder 2; 3a,3b denote two intake valves mounted to a cylinder head (not shown) by a valve spring and a valve spring retainer (not shown); 4a,4b denote two exhaust valves; and 5 denotes an ignition plug mounted to direct towards a center of the cylinder 2 in the cylinder head.

The intake valves 3a,3b opens and closes an inlet 7 by turning one of camshafts (not shown). The inlet 7 opens at the upper end of the cylinder 2 towards each of intake ports 6a,6b. Similarly, each of exhaust valves 4a, 4b opens and closes an outlet 9 of a branched exhaust port 8 by the other camshaft.

To the intake port 6a, an exhaust valve reflux pipe 10 connected to an exhaust manifold (not shown) is connected so that part of an exhaust gas may be controlled and refluxed by an EGR control valve (not shown) during high speed and high load operation. Thus, the intake valve 3a of the intake port 6a provides higher operation temperature and higher thermal load than the other intake valve 3b.

The intake valve 3a is made of higher heat resistant material, for example, martensitic heat-resistant steels such as SUH3 and SUH5 widely used as an ordinary intake valve and Cr steel such as 5Cr steel. The other intake valve 3b that has lower thermal load is made of lower heat resistant and less expensive material, for example carbon steel, general structural steel and light materials, for example Al alloys such as Al—Si and Al—Si—Cu and Ti alloys such as Ti64.

One 3b of the two intake valves that is made of inexpensive material reduces inertial mass of a valve-operating mechanism and mechanical loss such as friction, thereby increasing engine performance such as output and fuel rate. The exhaust valves 4a,4b are made of austenitic heat-resistant steel such as SUH35 or SUH36.

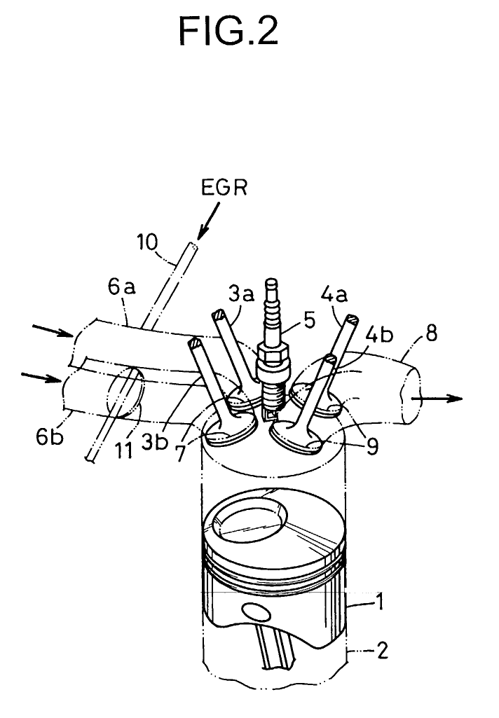

FIG. 2 illustrates the second embodiment of the present invention, in which a swirl control valve 11 is provided in an intake port 6b. By the control valve 11, an intake valve 3b is stopped during low and middle speed rotation, and an inlet 7 of an intake port 6a is closed, thereby forming swirl flow in a cylinder 2 to increase combustion rate.

In a multi-valve engine of this embodiment, the intake valve 3b which stores the swirl control valve 11 is always operated, and new air is brought repeatedly a cycle to increase cooling effect and to decrease thermal load. Similar to the above, lower heat resistance materials such as carbon steel, general structural steel, Al alloy or Ti alloy can be used.

In the intake valve 3a which stops during formation of swirl flow, cooling effect by new air is hindered, and owing to reflux of the exhaust gas, operation temperature rises to increase thermal load.

Thus, as material of the intake valve 3a, similar to the above, martensitic heat-resistant steel or higher heat-resistant austenitic steel may be employed.

The intake valve 3a provides decreased operation number compared with the other intake valve 3b to provide relatively low friction, and the material can be used. In the other intake valve 3b which is always operated, wear resistance treatment may be applied. For example, hard alloy such as stellite is padded on the valve face, or tufftriding may be applied to harden the whole valve.

To decrease thermal load of the intake valve 3a, relatively high heat-resistant and high heat-transferring materials such as Ti—Al intermetallic compounds and carbon steel are employed so that heat in a valve head may be escaped to a cylinder head via a valve seat and a valve guide, thereby increasing cooling effect.

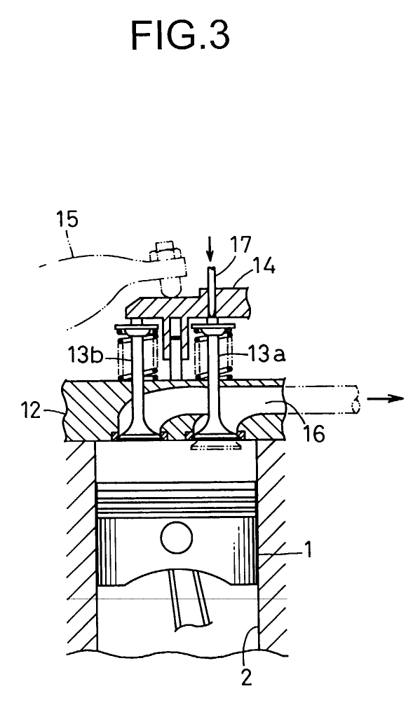

FIG. 3 illustrates the third embodiment in which part of muti-valve and multi-cylinder diesel engine is drawn. In a cylinder head 12, two intake valves (not shown) and two exhaust valves 13a,13b are mounted to each cylinder 2.

In exhaust valves 13a,13b, the middle of the upper surface of a T-shaped pressing member 14 is pressed by the end of a rocker arm 15 which is moved up and down by a cam of a cam shaft (not shown), so that the valves 13a,13b are operated at the same time to open and close a forked exhaust port 16.

Each of the intake valves is operated by a mechanism similar to the above to open and close an intake port (not shown).

In a multi-valve multi-cylinder diesel engine, there is an exhaust braking system in which an exhaust brake is operated to increase braking force by closing an exhaust shutter of an exhaust pipe (not shown).

In the exhaust braking system, one of the exhaust valve 13a is a little opened by a compression rod 17 of an actuator thereon, and an exhaust gas in an exhaust manifold is filled into a combustion chamber of the cylinder 2, to increase compression loss to increase braking force.

In a diesel engine which has such an exhaust braking system, high temperature exhaust gas passes through the exhaust valve 13a. Thus, the valve 13a becomes higher in temperature than the other exhaust valve 13b to increase thermal load.

Therefore, the exhaust valve 13a is made of heat- and wear-resistant materials comprising Ni heat-resistant superalloy such as NCF751 and NCF80A. Alternatively, the whole valve is made of austenitic heat-resistant steel such as SUH36 or SUH36, and a valve face is padded by Co hard metals (stellite), or Co or Ni intermetallic compounds (triballoy).

The other exhaust valve 13b is made of ordinary austenitic heat-resistant steel or Ti alloys such as Ti6242, or stellite is padded on a valve face.

The exhaust valve 13b that is subject to high thermal load is made of heat-resistant material and hard material is padded on the valve face that requires wear resistance, thereby increasing durability significantly to increase reliability of an engine.

The present invention is not limited to the foregoing embodiments. In the first and second embodiments, what requires heat resistance is mainly a valve head of the intake valve 3a, and the whole valve need not be made of higher heat resistance, but may be made of a welding-type intake valve 3a in which a valve stem made of low specific gravity material is bound with a valve head made of high heat resistance.

In the embodiment as shown in FIG. 3, only the valve head of the exhaust valve 13a requires heat resistance and wear resistance. The valve head is made of higher heat- and wear-resistant material, and the valve stem is made of relative low heat- and wear-resistant material, higher thermal conductive material or lower specific gravity material. The valve head is then combined with the valve stem.

Therefore, cooling capability of the exhaust valve 13a is increased and the valve 13a can be lightened.

Other than the foregoing multi-valve gasoline engine, the present invention is applied to a multi-valve gasoline engine which comprises EGR and a swirl control valve, a multi-valve having an internal EGR.

The foregoing merely relates to embodiments of the invention. Various changes and modifications may be made by persons skilled in the art without departing from the scope of claims wherein:

What is claimed is:

1. A multi-valve engine which has a plurality of intake and exhaust valves on a cylinder, one valve being made of material different from that of another valve depending on use.

2. A multi-valve engine as claimed in claim 1 wherein one intake valve is made of higher heat-resistant material, the other being made of lower heat-resistant material.

3. A multi-valve engine as claimed in claim 2 wherein the higher heat-resistant material is martensitic heat-resistant steel or Cr steel, while the lower heat-resistant material is carbon steel, general structural steel, Al alloy or Ti alloy.

4. A multi-valve engine as claimed in claim 1 wherein one of the intake valves has a swirl control valve and is made of lower heat-resistant material, the other intake valve being made of higher heat-resistant material.

5. A multi-valve engine as claimed in claim 4 wherein the higher heat-resistant material is martensitic or austenitic heat-resistant steel, the lower heat-resistant steel being carbon steel, general structural steel, Al alloy or Ti alloy.

6. A multi-valve engine as claimed in claim 1 wherein the engine comprises a diesel engine having an exhaust braking system, one of the exhaust valves comprising higher heat-resistant material, the other of the exhaust valves being made of lower heat-resistant material.

7. A multi-valve engine as claimed in claim 6 wherein the higher heat-resistant material is made of Ni super-heat-resistant alloy, austenitic heat-resistant steel, Co super hard alloy or Co/Ni intermetalic compound being padded on a valve face, the other of the exhaust valves being made of heat-resistant steel or Ti alloy.
